(19) United States
(12) Patent Application Publication
(10) Pub. No.: US 2016/0141663 A1
(43) Pub. Date: May 19, 2016

(54) METHOD OF CONTROLLING AIR FLOW IN FUEL CELL

(71) Applicant: Hyundai Motor Company, Seoul (KR)

(72) Inventors: Jae Hoon Kim, Suwon (KR); Hyo Seop Kim, Anseong (KR); Yei Sik Jeon, Seoul (KR)

(21) Appl. No.: 14/727,972

(22) Filed: Jun. 2, 2015

(30) Foreign Application Priority Data
Nov. 13, 2014 (KR) 10-2014-0157927

(51) Int. Cl. H01M 8/04

(52) U.S. Cl. CPC H01M 8/04223; H01M 8/04201

(57) ABSTRACT

The present disclosure relates to a method of controlling an air flow in a fuel cell, capable of periodically supplying air to a cathode and alleviating a rate at which a hydrogen concentration of an anode is decreased in an Idle stop state in which air supply to the cathode of a stack is stopped in order to suppress dry phenomenon of the fuel cell.

### CROSS-REFERENCE TO RELATED APPLICATION

This application claims the benefit of and priority to Korean Patent Application No. 10-2014-0157927, filed on Nov. 13, 2014 in the Korean Intellectual Property Office, the disclosure of which is incorporated herein in its entirety by reference.

### TECHNICAL FIELD

The present disclosure relates generally to a method of controlling an air flow in a fuel cell, and more particularly, to a method of controlling an air flow in a fuel cell capable of periodically supplying air to the fuel cell in an Idle stop state to alleviate a rate at which a hydrogen concentration of an anode is decreased.

### BACKGROUND

A section without an output of a fuel cell in a fuel cell system refers to an Idle section. In the Idle section, since an electrochemical reaction is not generated in the fuel cell, water (H₂O) is not produced.

In the Idle section, air supply to a cathode is stopped in order to improve a system efficiency and suppress a dry phenomenon of the fuel cell in which a percentage of water content is decreased. This operation method generally refers to an Idle stop. That is, an operation of an air supplier to the cathode (e.g., a mass flow controller (MFC), an air blower, a compressor, or the like) is stopped to interrupt the air supply to the cathode, and consumption power (i.e., energy) of auxiliary machinery (e.g., single products operated to drive the fuel cell such as a valve, a pump, and the like) is reduced to increase an efficiency of the fuel cell system. Meanwhile, at the time of sudden unintended acceleration, an anode continuously supplies and maintains a predetermined required amount of hydrogen in order to secure response ability of the fuel cell system.

In the Idle stop section, a phenomenon where a hydrogen concentration of the anode is decreased over time occurs, such that at the time of restart of the fuel cell system, the hydrogen concentration of the anode is maintained to be low. When the hydrogen concentration of the anode is maintained to be low, durability of a fuel cell stack is weakened, and therefore, performance of the fuel cell is deteriorated which has a negative influence on operational safety of the fuel cell system.

In particular, after the Idle stop, some performance of the fuel cell is decreased due to a low hydrogen concentration. There is a possibility to require a spontaneous high output, such as sudden unintended acceleration. In order to protect the fuel cell stack in this case, there is no choice but to limit an output, which causes the response ability of the fuel cell system to be hindered. After the Idle stop, in order to increase the response ability of the fuel cell system, hydrogen is continuously supplied to the anode. Here, hydrogen supplied to the anode is continuously consumed due to chemical reaction with oxygen in the cathode, and an oxygen concentration in the cathode is decreased to 21 percent or less. When the oxygen concentration is decreased, a nitrogen concentration is relatively increased to greater than 79 percent, which is equivalent to a general nitrogen concentration in the air.

In addition, due to osmotic pressure phenomenon, nitrogen is moved from the cathode having relatively high nitrogen concentration to the anode having relatively low nitrogen concentration through an electrolyte membrane. Therefore, the nitrogen concentration of the anode is greater than that of an initial stage of an Idle stop entry, and consequentially, the hydrogen concentration of the anode is decreased.

### SUMMARY

The present disclosure has been made to solve the above-mentioned problems occurring in the related art while advantages achieved by the related art are maintained intact.

An aspect of the present disclosure provides a method of controlling an air flow in a fuel cell capable of alleviating a rate at which a hydrogen concentration of an anode is decreased in an Idle stop state to improve response ability of a fuel cell system.

According to embodiments of the present disclosure, a method of controlling an air flow in a fuel cell includes: periodically supplying air to a cathode in an Idle stop state in which an air supply to the cathode of a stack is stopped in order to suppress dry phenomenon of the fuel cell.

The periodic supplying of air may include: periodically supplying the air to the cathode in the Idle stop state with a predetermined flow at a predetermined time interval for a predetermined time.

The periodic supplying of air may include: periodically supplying the air to the cathode in the Idle stop state through an air supplier provided in a fuel cell system.

The air supplier may include any one of an air blower, a mass flow controller (MFC), a fan, and a compressor.

Furthermore, according to embodiments of the present disclosure, a method of controlling an air flow in a fuel cell includes: generating an Idle stop entry signal; stopping an operation of an air supplier provided in a fuel cell system; and periodically operating the air supplier to periodically supply air to a cathode.

The method may further include: determining whether or not an Idle stop release signal is generated in the fuel cell system.

The method may further include: re-operating the air supplier wherein when the Idle stop release signal is generated.

The method may further include: measuring an air flow supplied to the cathode when the air supplier is re-operated; and determining whether or not the measured air flow is larger than a necessary air flow, the necessary air flow being an air amount required when an output in the fuel cell system is generated.

The fuel cell system may start to generate the output when the measured air flow is larger than the necessary air flow.

The air flow introduced to the cathode may be increased when the measured air flow is smaller than the necessary air flow.

Furthermore, according to embodiments of the present disclosure, a non-transitory computer readable medium containing program instructions for controlling an air flow in a fuel cell includes: program instructions that periodically supply air to a cathode in an Idle stop state.

Furthermore, according to embodiments of the present disclosure, a non-transitory computer readable medium containing program instructions for controlling an air flow in a fuel cell includes: program instructions that generate an Idle stop entry signal; program instructions that stop an operation of an air supplier provided in a fuel cell system; and program instructions that periodically operate the air supplier to periodically supply air to a cathode.

### BRIEF DESCRIPTION OF THE DRAWINGS

The above and other objects, features and advantages of the present disclosure will be more apparent from the following detailed description taken in conjunction with the accompanying drawings.

FIG. 1 is a flow chart illustrating a method of controlling an air flow in a fuel cell according to embodiments of the present disclosure.

FIG. 2 is a block diagram illustrating controlling of the method of controlling an air flow in a fuel cell of FIG. 1.

FIG. 3 is a graph illustrating an hourly change of an air flow supplied to the fuel cell in an Idle stop state according to the method of controlling an air flow in a fuel cell of FIG. 1.

FIG. 4 is a graph illustrating comparison of the air flow supplied to the fuel cell and a hydrogen concentration of an anode in the Idle stop state according to the method of controlling an air flow in a fuel cell of FIG. 1.

FIG. 5 is a graph illustrating comparison between the hydrogen concentration in the Idle stop state according to the related art and the hydrogen concentration in the Idle stop state to which the method of controlling an air flow in a fuel cell of FIG. 1 is applied.

### DETAILED DESCRIPTION OF THE EMBODIMENTS

Hereinafter, embodiments of the present disclosure will be described in detail with reference to the accompanying drawings. As those skilled in the art would realize, the described embodiments may be modified in various different ways, all without departing from the spirit or scope of the present disclosure. Further, throughout the specification, like reference numerals refer to like elements.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Additionally, it is understood that one or more of the below methods, or aspects thereof, may be executed by at least one controller. The term “controller” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the controller in conjunction with one or more other components, as would be appreciated by a person of ordinary skill in the art.

Furthermore, the controller of the present disclosure may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

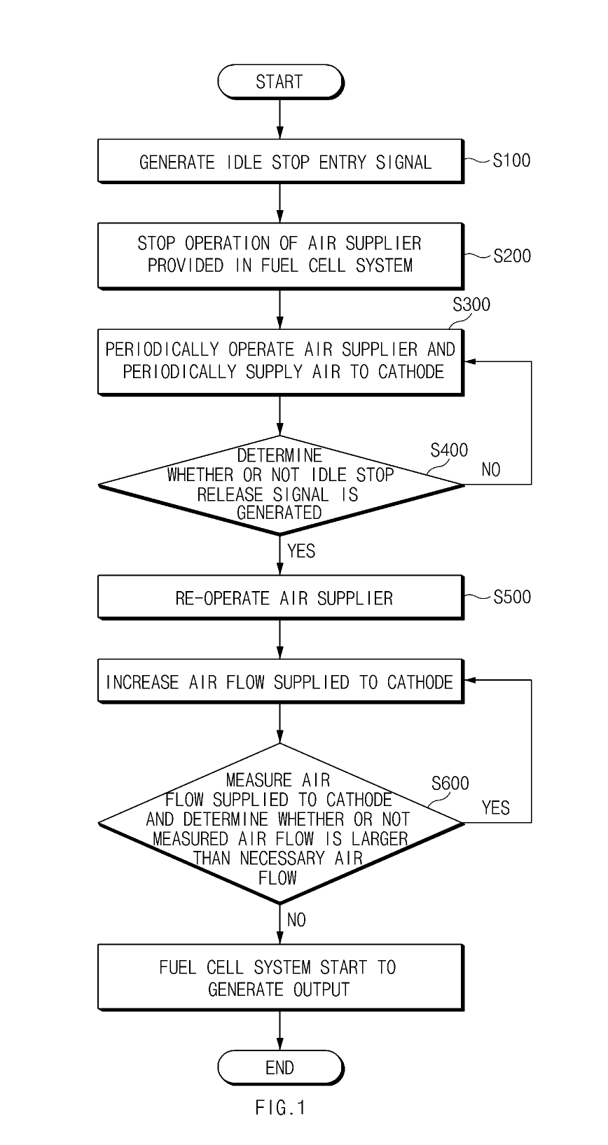

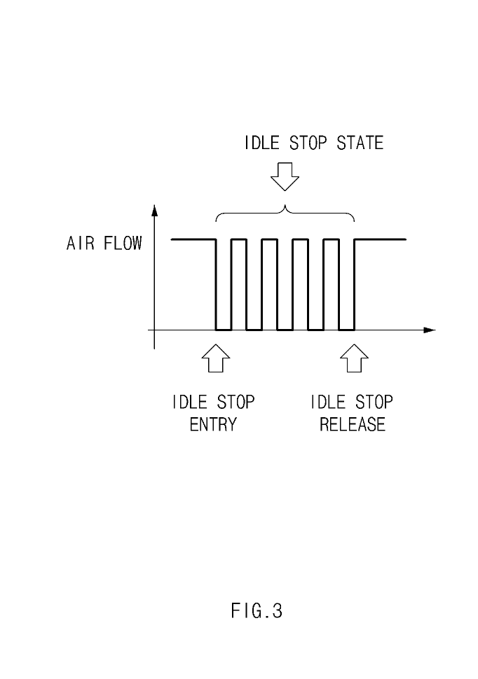

Referring now to the disclosed embodiments, as shown in FIGS. 1 to 5, a method of controlling an air flow in a fuel cell of the present disclosure includes periodically supplying air to a cathode 200 in an Idle stop state in which air supply to the cathode 200 of a stack is stopped in order to suppress dry phenomenon of the fuel cell S300. The air supplied to the cathode 200 in an Idle stop state is supplied with a predetermined flow at a predetermined time interval for a predetermined time. A supply time, a supply interval, and a supply flow are changeable depending on characteristic and a state of a fuel cell system (e.g., see FIG. 3).

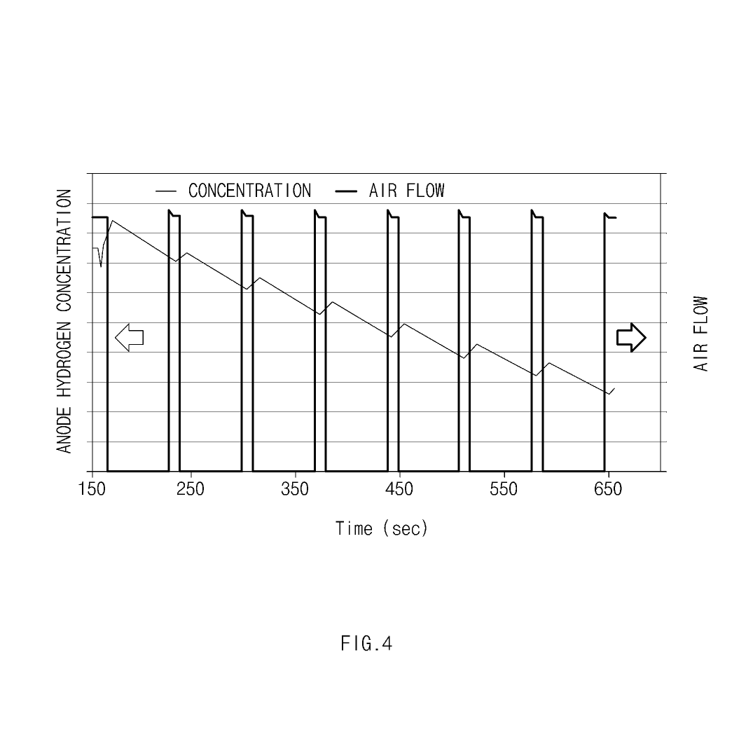

Air is periodically supplied to the cathode 200 in the Idle stop state, through an air supplier 100 provided in the fuel cell system. The air supplier 100 is any one of an air blower, a mass flow controller (MFC), a fan, and a compressor. When the air is periodically supplied to the cathode 200 in the Idle stop state, a nitrogen concentration in the cathode 200 is maintained to be close to 79 percent which is a general nitrogen concentration in the air, and is decreased than the existing Idle stop state. Therefore, the nitrogen movement from the cathode 200 to the anode is decreased, and therefore, a nitrogen amount of the anode is constantly maintained. As a result, the air is periodically introduced to the cathode 200, such that newly supplied oxygen and hydrogen present in the cathode 200 chemically react with each other to decrease a hydrogen concentration, but the nitrogen concentration is not changed. Therefore, a rate at which the hydrogen concentration of the anode is decreased may be alleviated (e.g., see FIG. 4).

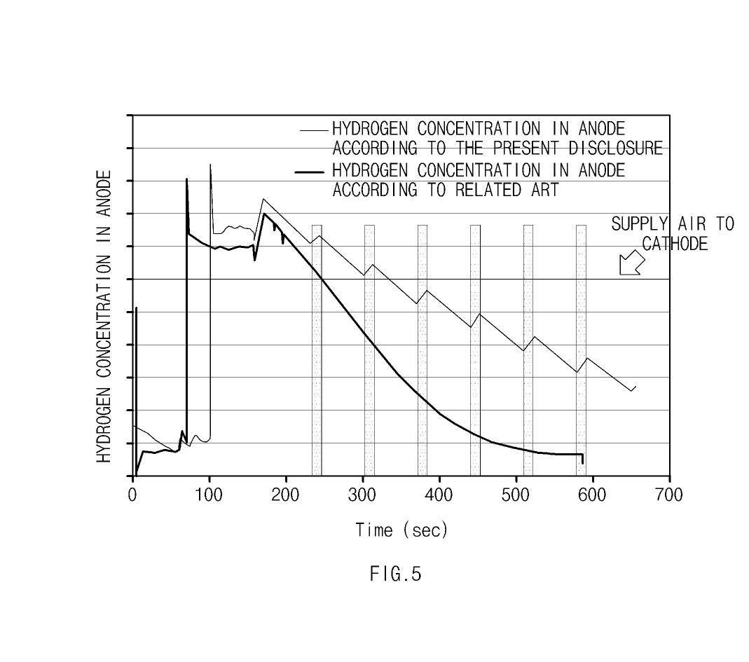

As shown in FIG. 5, according to the present disclosure, it may be confirmed that a required time for which the hydrogen concentration of the anode is decreased up to a specific hydrogen concentration is greater than that of the related art. In the present disclosure, the rate at which the hydrogen concentration of the anode is decreased is less than that of the related art, such that frequency of hydrogen discharge for maintaining a predetermined hydrogen concentration may be decreased. Therefore, a hydrogen utilization rate and efficiency of the fuel cell stack may be improved. In addition, the anode is maintained to have a greater hydrogen concentration as compared to the related art. Thus, operational safety of the fuel cell may be improved.

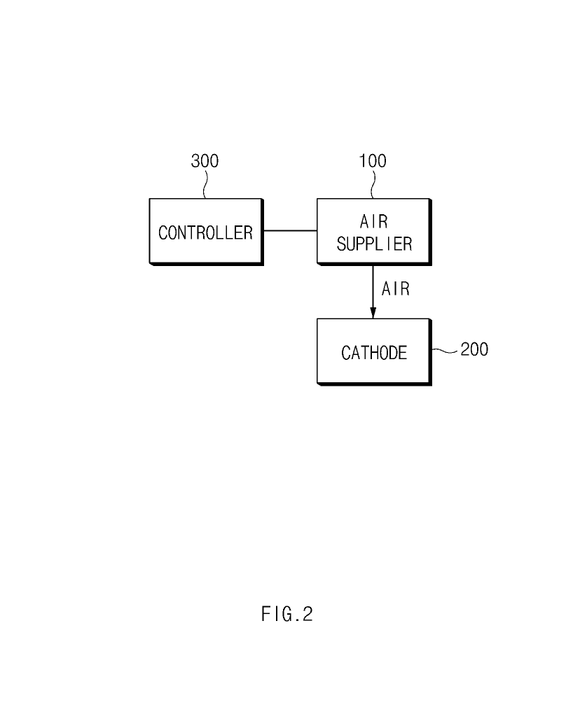

Embodiments of the present disclosure as described above are described in more detail hereinbelow. As shown in FIGS. 1 and 2, the method of controlling an air flow in a fuel cell according to embodiments of the present disclosure includes generating an Idle stop entry signal in which the air supply to the cathode 200 is stopped in order to suppress dry phenomenon of the fuel cell, in a controller 300 S100; and stopping an operation of the air supplier 100 provided in a fuel cell system S200; and periodically operating the air supplier 100, and periodically supplying air to a cathode 200 S300.

In addition, the method may further include a step of determining whether or not an Idle stop release signal is generated in the fuel cell system S400. In addition, when the Idle stop release signal is generated, the air supplier 100 is re-operated S500.

When the air supplier 100 is re-operated, an air flow supplied to the cathode 200 is measured, and whether or not the measured air flow is larger than a necessary air flow is determined, the necessary air flow being an air amount required when an output in the fuel cell system is generated S600. When the measured air flow is larger than the necessary air flow, the fuel cell system starts to generate the output, and applies a power to a driving motor, electronics, and the like. When the measured air flow is smaller than the necessary air flow, the air flow introduced into the cathode 200 of the stack is increased.

With the method of controlling an air flow in a fuel cell, as described above, the rate at which the hydrogen concentration of the anode is decreased may be alleviated in the Idle stop state. In addition, due to a decrease in frequency of hydrogen discharge of the anode, a hydrogen utilization rate may be improved and eventually, fuel efficiency may be improved. Further, since a state in which a relatively high hydrogen concentration of the anode is maintained for a long period of time as compared to the related art, the fuel cell may have improved durability. In addition, the state in which the relatively high hydrogen concentration of the anode may be maintained to provide excellent voltage distribution of the fuel cell, such that operational safety of the fuel cell system may be improved.

Although the present disclosure has been described with reference to embodiments and the accompanying drawings, it would be appreciated by those skilled in the art that the present disclosure is not limited thereto but various modifications and alterations might be made without departing from the scope defined in the claims and their equivalents.

What is claimed is:

1. A method of controlling an air flow in a fuel cell, comprising:
periodically supplying air to a cathode in an Idle stop state.

2. The method according to claim 1, wherein the periodic supplying of air comprises:
periodically supplying the air to the cathode in the Idle stop state with a predetermined flow at a predetermined time interval for a predetermined time.

3. The method according to claim 1, wherein the periodic supplying of air comprises:
periodically supplying the air to the cathode in the Idle stop state through an air supplier provided in a fuel cell system.

4. The method according to claim 3, wherein the air supplier includes any one of an air blower, a mass flow controller (MFC), a fan, and a compressor.

5. A method of controlling an air flow in a fuel cell, comprising:
generating an Idle stop entry signal;
stopping an operation of an air supplier provided in a fuel cell system; and
periodically operating the air supplier to periodically supply air to a cathode.

6. The method according to claim 5, further comprising:
determining whether or not an Idle stop release signal is generated in the fuel cell system.

7. The method according to claim 6, further comprising:
re-operating the air supplier wherein when the Idle stop release signal is generated.

8. The method according to claim 7, further comprising:
measuring an air flow supplied to the cathode when the air supplier is re-operated; and
determining whether or not the measured air flow is larger than a necessary air flow, the necessary air flow being an air amount required when an output in the fuel cell system is generated.

9. The method according to claim 8, wherein the fuel cell system starts to generate the output when the measured air flow is larger than the necessary air flow.

10. The method according to claim 8, wherein the air flow introduced to the cathode is increased when the measured air flow is smaller than the necessary air flow.

11. A non-transitory computer readable medium containing program instructions for controlling an air flow in a fuel cell, the computer readable medium comprising:
program instructions that periodically supply air to a cathode in an Idle stop state.

12. A non-transitory computer readable medium containing program instructions for controlling an air flow in a fuel cell, the computer readable medium comprising:
program instructions that generate an Idle stop entry signal;
program instructions that stop an operation of an air supplier provided in a fuel cell system; and
program instructions that periodically operate the air supplier to periodically supply air to a cathode.
